(19) United States
(12) Patent Application Publication
(10) Pub. No.: US 2026/0269403 A1
(43) Pub. Date: Sep. 10, 2026

(54) BATTERY FRAME AND CARRIER

(71) Applicants: University of Sanya, Sanya, Hainan (CN); ZHEJIANG GEELY HOLDING GROUP CO., LTD., Hangzhou, Zhejiang (CN)

(72) Inventor: Shufu LI, Sanya, Hainan (CN)

(73) Assignees: University of Sanya, Sanya, Hainan (CN); ZHEJIANG GEELY HOLDING GROUP CO., LTD., Hangzhou, Zhejiang (CN)

(21) Appl. No.: 19/491,347

(22) PCT Filed: Jun. 28, 2024
(86) PCT No.: PCT/CN2024/102243

§ 371 Date: Dec. 8, 2025

(30) Foreign Application Priority Data
Jun. 30, 2023 (CN) 202310800174.5

(51) Int. Cl. H01M 50/242; H01M 50/224; H01M 50/256; H01M 50/262; H01M 50/276

(52) U.S. Cl. CPC H01M 50/242; H01M 50/224; H01M 50/256; H01M 50/262; H01M 50/276

(57) ABSTRACT

A battery frame and a carrier. The battery frame includes a bottom plate (10) and two side plates (20), where the bottom plate (10) and the two side plates (20) are of a profile type integrally formed structure. The two side plates (20) are symmetrically connected to two sides of the bottom plate (10). The bottom plate (10) and the two side plates (20) enclose to form a channel body (11) with an upward opening. Two ends of the channel body (11) in the length direction each has an opening. Inner side walls of the two side plates each protrudes to form a plurality of boss portions (21). The boss portions (21) and the two side plates (20) enclose to form accommodating cavities (23) for mounting power batteries (90).

### CROSS-REFERENCE TO RELATED APPLICATION

This application claims priority to Chinese Patent Application No. 202310800174.5, filed with the China Patent Office on Jun. 30, 2023, the entire contents of which are incorporated herein by reference.

### TECHNICAL FIELD

Embodiments of the present application relate to, but are not limited to, the field of carrier technologies, and in particular, to, but not limited to, a battery frame and a carrier.

### BACKGROUND

As the power source for pure electric heavy-duty trucks, power batteries require strict protection. The power battery frame primarily provides a safe working environment for the power battery, ensuring that the power battery does not deform and cause fire or combustion in the event of a vehicle collision.

### SUMMARY

Below is a summary of the subject matters described in detail herein. The summary is not intended to limit the protection scope of the claims.

According to a first aspect of the embodiments of the present application, there is provided a battery frame, including: a bottom plate and two side plates, where the bottom plate and the two side plates are of an integrally formed structure; the two side plates are symmetrically connected to two sides of the bottom plate, the bottom plate and the two side plates enclose to form a channel body with an upward opening, and two ends of the channel body, in a length direction, each has an opening;
inner side walls of the two side plates each protrudes to form a plurality of boss portions, and the plurality of boss portions and the two side plates enclose to form one or more accommodating cavities for mounting power batteries.

In some embodiments, at least one of the bottom plate and the two side plates is of a porous profile-type structure; and/or
the bottom plate and the two side plates are of an aluminum alloy integrated structure.

In some embodiments, the battery frame further includes a cover plate, connected to a top of the channel body, configured to cover the upward opening of the channel body.

In some embodiments, the cover plate is connected and fixed to the channel body via an adhesive or fasteners; and/or
the cover plate is an integrally formed aluminum alloy cover plate; and/or
the cover plate is of a porous profile-type structure.

In some embodiments, the battery frame further includes two protective plates, respectively connected to the two ends of the channel body in the length direction, configured to respectively cover openings at the two ends of the channel body in the length direction.

In some embodiments, a protective plate of the two protective plates is connected and fixed to the channel body via an adhesive or fasteners; and/or
the protective plate is an integrally formed aluminum alloy protective plate; and/or
the protective plate is of a porous profile-type structure.

In some embodiments, the battery frame further includes a mounting bracket, connected to a bottom of the channel body.

In some embodiments, the mounting bracket is connected and fixed to the channel body via fasteners.

In some embodiments, top portions of the inner side walls of the two side plates each protrudes to form a mounting portion, a distance between two mounting portions in a width direction is less than a width of the bottom plate; two mounting portions are at the same height.

In some embodiments, a width of each of the plurality of boss portions is less than a width of the bottom plate; a plurality of boss portions on a same side plate are arranged spaced apart in a height direction of the side plate, the plurality of boss portions on the two side plates are symmetrically arranged in the height direction of the side plates, two boss portions at a same height and the two side plates enclose to form one of the one or more accommodating cavities, and a distance between the two boss portions at the same height in the width direction is less than the width of the bottom plate; and/or
two boss portions at lowermost positions of the two side plates abut against the bottom plate.

According to a second aspect of the embodiments of the present application, there is provided a carrier is provided including at least one power battery and the battery frame according to the first aspect, where the at least one power battery is mounted in the one or more accommodating cavities.

In some embodiments, the at least one power battery includes an electric core, and inner walls of the one or more accommodating cavities surround the electric core to serve as a housing of the at least one power battery.

The technical solutions provided by the embodiments of the present application may include the following beneficial effects:

The battery frame of the present application processes the bottom plate and the two side plates into a highly integrated profile-type integrally formed structure, which has a simple structure, does not require additional components, effectively reduces the weight of the battery frame, and meets the requirement of light weight. The battery frame of the present application avoids the current connection methods of welding and bolts for battery frames, simplifies the assembly process, reduces assembly time, and lowers manufacturing costs.

It should be understood that the above general description and the following detailed description are merely exemplary and explanatory, and are not intended to limit the present application. Other aspects will be apparent after reading and understanding the drawings and detailed description.

### BRIEF DESCRIPTION OF DRAWINGS

The accompanying drawings, which are incorporated in and constitute a part of the specification, illustrate embodiments consistent with the present application and, together with the description, serve to explain the principles of the present application.

FIG. 1 is a schematic cross-sectional view of a profile-type integrated battery frame according to an embodiment of the present application.

FIG. 2 is a schematic structural view of the profile-type integrated battery frame after mounting a power battery according to an embodiment of the present application.

FIG. 3 is an exploded view of the profile-type integrated battery frame according to an embodiment of the present application.

### REFERENCE SIGNS

10—bottom plate, 11—channel body, 20—side plate, 21—boss portion, 22—mounting portion, 23—accommodating cavity, 30—cover plate, 40—protective plate, 50—mounting bracket, 90—power battery.

### DETAILED DESCRIPTION

Exemplary embodiments will be described in detail herein, with examples illustrated in the accompanying drawings. When the following description refers to the drawings, unless otherwise indicated, the same numerals in different drawings represent the same or similar elements. The embodiments described in the following examples do not represent all implementations consistent with the present application. Instead, they are merely examples of devices consistent with certain aspects of the present application, as detailed in the appended claims.

The terminology used herein is for the purpose of describing particular embodiments only and is not intended to limit the application. Unless otherwise defined, technical or scientific terms used herein shall have the meanings commonly understood by those skilled in the art. The terms “first,” “second,” and similar expressions used in the specification and claims of the present application do not denote any order, quantity, or importance, but are merely used to distinguish between different components. Similarly, the terms “a” or “an” do not denote a numerical limitation but indicate the presence of at least one. If it refers to “one” specifically, it will be mentioned separately. The term “plurality” or “several” refers to two or more. Unless otherwise specified, terms such as “front,” “rear,” “lower,” “upper,” “top,” and “bottom” are used for convenience of description and are not limited to a specific position or spatial orientation. The terms “include,” “comprise,” or similar expressions indicate that the elements or objects preceding these terms encompass the elements or objects listed thereafter and their equivalents, but do not exclude other elements or objects. The terms “connect,” “couple,” or similar expressions are not limited to physical or mechanical connections but may include electrical connections, whether direct or indirect.

The terminology used in the present application is for the purpose of describing particular embodiments only and is not intended to limit the present application. The singular forms “a,” “said,” and “the” used in the specification and claims of the present application are also intended to include plural forms, unless the context clearly indicates otherwise. It should also be understood that the term “and/or” as used herein refers to and encompasses any or all possible combinations of one or more associated listed items.

As the power source for pure electric heavy-duty trucks, power batteries require strict protection. The power battery frame primarily provides a safe working environment for the power battery, ensuring that the power battery does not deform and cause fire or combustion in the event of a vehicle collision. As an important component of pure electric heavy-duty trucks, the power battery frame has high requirements not only for safety performance but also for light weight. Currently, power battery frames mostly adopt a frame structure composed of rectangular steel tubes and steel protective plates, connected by welding and bolts, resulting in a relatively complex structure, heavy weight, long production cycle, which is not conducive to mass production.

The present application provides a battery frame and a carrier. The battery frame and carrier of the present application will be described in detail below with reference to the drawings. The features of the following embodiments and examples may be combined with each other without conflict.

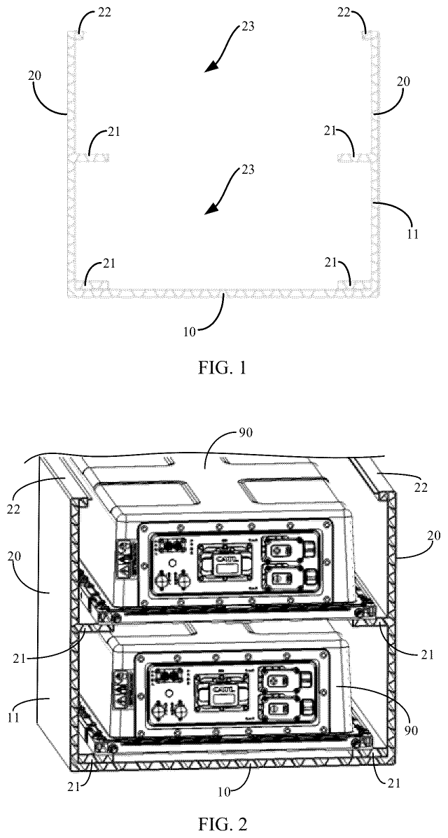

Referring to FIG. 1 to FIG. 3, an embodiment of the present application provides a battery frame, which can be applied to carriers such as automobiles and ships. For example, it can be applied to commercial vehicles such as new energy vehicles or fuel vehicles. Commercial vehicles may include cargo vehicles, lorries, semi-trailer tractors, flatbed trailers, trucks, heavy-duty trucks, light trucks, and other vehicles. The battery frame includes: a bottom plate 10 and two side plates 20, where the bottom plate 10 and the two side plates 20 are of an integrally-formed structure, such as an extruded profile integrated molding structure, where extruded profile integrated molding structure is a structure of special extrusion molding, a length of the profile-type structure is very long, and a cross-section of the profile-type structure is integral. Herein, the term “extruded profile integrated molding structure” refers to a profile-type structure formed by using a process similar to profile-type integral extrusion molding. The two side plates 20 are symmetrically connected to two sides of the bottom plate 10, the bottom plate 10 and the two side plates 20 enclose to form a channel body 11 with an upward opening, and two ends of the channel body 11, in a length direction X (as shown in FIG. 3), each has an opening.

Inner side walls of the two side plates 20 each protrudes to form a plurality of boss portions 21, and the plurality of boss portions 21 and the two side plates 20 enclose to form one or more accommodating cavities 23 for mounting power batteries 90.

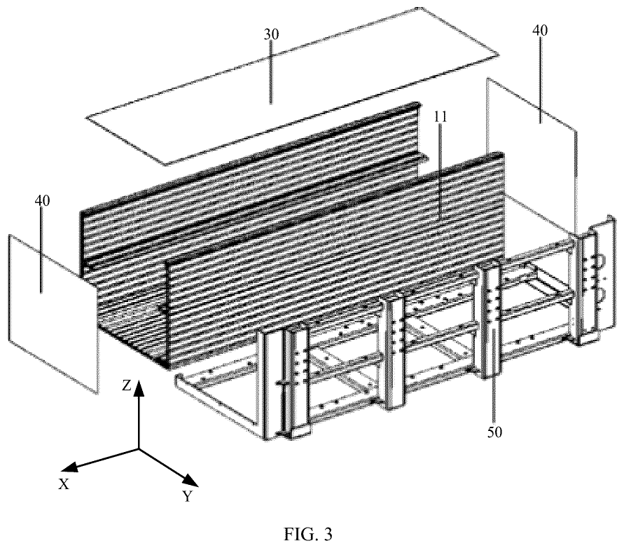

It should be noted that a number of boss portions 21 and a number of accommodating cavities 23 can be set according to the actual number of power batteries to be mounted, which is not limited in this application. As shown in FIG. 2, an application scenario with two layers of battery packs (i.e., power batteries) is shown. Two power batteries are respectively mounted in the two accommodating cavities 23 of the upper layer and lower layer, and the power batteries 90 are supported on the boss portions 21.

The battery frame provided by the embodiment of the present application processes the bottom plate 10 and the two side plates 20 into a highly integrated extruded profile integrated molding structure, which has a simple structure, does not require additional parts for assembly and connection, enables faster and more efficient mounting, effectively reduces the weight of the battery frame, and meets the design requirements of the lightweight trend for battery frames. The battery frame of the present application avoids the current connection methods of welding and bolts for power battery frames, simplifies the assembly process, reduces assembly time, and lowers manufacturing costs.

In some embodiments, at least one of the inner walls of the side plates 20 and the boss portion 21 is provided with a guide groove to facilitate the assembly of the power battery 90. The power battery 90 as a whole is pushed into the accommodating cavity 23 along the length direction X through the guide groove for assembly.

In some embodiments, the bottom plate 10 and the two side plates 20 are of an aluminum alloy integrated structure, such as an extruded profile integrated molding aluminum alloy structure. The bottom plate 10 and the two side plates 20 are an integrally-formed structure formed by extrusion molding, that is, an aluminum alloy material is forcibly extruded through a die by an extrusion molding process to form the integrally-formed structure of the bottom plate 10 and the two side plates 20. Cross-sections of the integrally-formed structure perpendicular to the longitudinal direction are identical. Using an aluminum alloy integrated structure can significantly reduce the weight of the battery frame while ensuring structural strength.

In some embodiments, at least one of the bottom plate 10 and the two side plates 20 is of a porous profile-type structure. It can be understood that at least one of the bottom plate 10 and the two side plates 20 is formed by extrusion molding into, for example, a corrugated plate structure to strengthen and improve the strength and stiffness of the battery frame. An inner corner position of at least one of the bottom plate 10 and the two side plates 20 is formed with a cavity portion by extrusion molding. Thus, extruding small cavity portions at the inner corner positions of the extruded-and-integrally formed aluminum alloy battery frame can greatly enhance the bending resistance of the extruded-and-integrally formed aluminum alloy battery frame.

In some embodiments, the battery frame may further include a cover plate 30, connected to the top of the channel body 11, configured to cover the upward opening of the channel body 11. Thus, the cover plate 30 and the channel body 11 combine to form a structure that is closed on four sides and has openings at both ends along the length direction X, which can enclose the power battery within the battery frame, protecting the power battery 90 and improving the appearance.

In some embodiments, the cover plate 30 is an extruded profile integrated molding aluminum alloy cover plate, which can be formed by forcibly extruding an aluminum alloy material through a die by an extrusion molding process to form an integrally formed aluminum alloy cover plate. Cross-sections of the integrally-formed structure perpendicular to the longitudinal direction are identical. Using an aluminum alloy cover plate can significantly reduce the weight of the battery frame while ensuring structural strength.

In some embodiments, the cover plate 30 is of a porous profile-type structure. It can be understood that the cover plate 30 is formed by extrusion molding into, for example, a corrugated plate structure to strengthen and improve the strength and stiffness of the battery frame. An inner corner position of the cover plate 30 is formed with a cavity portion by extrusion molding. Thus, extruding small cavity portions at the inner corner positions of the extruded-and-integrally formed aluminum alloy battery frame can greatly enhance the bending resistance of the extruded-and-integrally formed aluminum alloy battery frame.

In some embodiments, the cover plate 30 is connected and fixed to the channel body 11 via an adhesive or fasteners. For example, the cover plate 30 can be adhesively fixed to the channel body 11 with adhesive. Alternatively, the cover plate 30 can be connected and fixed to the channel body 11 with bolts. Alternatively, the cover plate 30 can also be connected and fixed to the channel body 11 by welding.

In some embodiments, top portions of the inner side walls of the two side plates 20 each protrudes to form a mounting portion 22. A width of the mounting portion 22 is less than a width of the bottom plate 10, for example, a width of each mounting portion 22 is less than half the width of the bottom plate 10. Two mounting portions 22 are at the same height. It can be understood that the mounting portion 22 can be used for connection and fixation with the cover plate 30, facilitating the mounting of the cover plate 30 and the channel body 11.

In some embodiments, as shown in FIG. 3, the battery frame may further include two protective plates 40, respectively connected to the two sides of the channel body 11 in the length direction X, configured to cover the two openings of the channel body 11. Thus, the two protective plates 40, the cover plate 30, and the channel body 11 combine to form a fully enclosed structure, enclosing the power battery 90 inside, which protects the power battery 90 and improves the appearance.

In some embodiments, the protective plate 40 is a profile-type extruded-and-integrally formed aluminum alloy protective plate, which can be formed by forcibly extruding an aluminum alloy material through a die by an extrusion molding process to form an integrally formed aluminum alloy protective plate. Cross-sections of the integrally-formed structure perpendicular to the longitudinal direction are identical. Using an aluminum alloy protective plate can significantly reduce the weight of the battery frame while ensuring structural strength.

In some embodiments, the protective plate 40 is of a porous profile-type structure. It can be understood that the protective plate 40 can be formed by extrusion molding into, for example, a corrugated plate structure to strengthen and improve the strength and stiffness of the battery frame. An inner corner position of the protective plate 40 can be formed with a cavity portion by extrusion molding. Thus, extruding small cavity portions at the inner corner positions of the extruded-and-integrally formed aluminum alloy battery frame can greatly enhance the bending resistance of the extruded-and-integrally formed aluminum alloy battery frame.

In some embodiments, the protective plate 40 is connected and fixed to the channel body 11 via an adhesive or fasteners. For example, the protective plate 40 is adhesively fixed to the channel body 11 with adhesive. Alternatively, the protective plate 40 is connected and fixed to the channel body 11 with bolts. Alternatively, the protective plate 40 is connected and fixed to the channel body 11 by welding.

In some embodiments, the battery frame may further include a mounting bracket 50, connected to the bottom of the channel body 11. The mounting bracket 50 can be connected and fixed to other components of the carrier, thereby mounting the battery frame on the carrier. In some embodiments, the mounting bracket 50 is connected and fixed to the channel body 11 via fasteners (e.g., bolts). Alternatively, the mounting bracket 50 is connected and fixed to the channel body 11 by welding.

In some embodiments, a width of the boss portion 21 is less than the width of the bottom plate 10, for example, a width of each boss portion is less than half the width of the bottom plate 10, the width direction Y is as shown in FIG. 3. A plurality of the boss portions 21 on a same side plate 20 are arranged spaced apart along a height direction Z of the side plate 20, a plurality of boss portions 21 on the two side plates 20 are symmetrically arranged along the height direction Z of the side plate 20, two boss portions 21 at the same height and the two side plates 20 enclose to form the accommodating cavity 23, and the power battery 90 can be supported on the two boss portions 21 at the same height. This arrangement can improve the stability of the power battery 90.

In some embodiments, two boss portions 21 at lowermost positions of the two side plates abut against the bottom plate 10. This arrangement can improve the structural strength at the bottom of the battery frame.

An embodiment of the present application further provides a carrier, including at least one power battery 90 and the battery frame as described in the above embodiments, where the power battery 90 is mounted in the accommodating cavity 23 of the battery frame.

The carrier provided by the embodiment of the present application adopts a profile-type integrated battery frame, which processes the bottom plate 10 and the two side plates 20 into a highly integrated extruded profile integrated molding structure. This structure is simple, does not require additional parts for assembly and connection, enables faster and more efficient mounting, effectively reduces the weight of the battery frame, and meets the design requirements of the lightweight trend. The extruded profile integrated molding structure avoids the current connection methods of welding and bolts for battery frames, simplifies the assembly process, reduces assembly time, and lowers manufacturing costs.

In some embodiments, the power battery 90 includes an electric core, and inner walls of the accommodating cavity 23 surround the electric core to serve as a housing of the power battery 90. This arrangement integrates the battery frame and the housing of the battery electric core into one structure, further reducing the weight of the battery frame. Moreover, due to the extensive use of aluminum alloy material, which has the advantages of being recyclable and reusable, and due to the application and high integration of aluminum alloy material, as well as the high integration of the battery frame, the weight of the battery frame can be effectively reduced.

Those skilled in the art will readily contemplate other embodiments of the present application after considering the specification and practicing the application disclosed herein. The application is intended to cover any variations, uses, or adaptive changes of the present application, which follow the general principles of the present application and include common general knowledge or conventional technical means in the art not disclosed in the present application. The description and examples are to be regarded as exemplary only, and the true scope and spirit of the present application are indicated by the following claims.

It should be understood that the present application is not limited to the precise structure that has been described above and illustrated in the drawings, and that various modifications and changes can be made without departing from the scope thereof. The scope of the present application is limited only by the appended claims.

1. A battery frame, comprising: a bottom plate; and two side plates,
wherein the bottom plate and the two side plates are of an integrally-formed structure;
wherein the two side plates are symmetrically connected to two sides of the bottom plate, the bottom plate and the two side plates enclose to form a channel body with an upward opening, and two ends of the channel body, in a length direction, each has an opening; and
wherein inner side walls of the two side plates each protrudes to form a plurality of boss portions, and the plurality of boss portions and the two side plates enclose to form one or more accommodating cavities for mounting power batteries.

2. The battery frame according to claim 1, wherein at least one of the bottom plate and the two side plates is of a porous profile-type structure.

3. The battery frame according to claim 1, wherein the bottom plate and the two side plates are of an aluminum alloy integrated structure.

4. The battery frame according to claim 1, further comprising a cover plate wherein the cover plate is connected to a top of the channel body, and configured to cover the upward opening of the channel body.

5. The battery frame according to claim 4, wherein the cover plate is connected and fixed to the channel body via an adhesive or fasteners.

6. The battery frame according to claim 1, further comprising two protective plates, respectively connected to the two ends of the channel body in the length direction, configured to respectively cover the two openings at the two ends of the channel body in the length direction.

7. The battery frame according to claim 6, wherein the protective plate is connected and fixed to the channel body via an adhesive or fasteners;

8. The battery frame according to claim 1, further comprising a mounting bracket connected to a bottom of the channel body.

9. The battery frame according to claim 8, wherein the mounting bracket is connected and fixed to the channel body via fasteners.

10. The battery frame according to claim 1, wherein top portions of the inner side walls of the two side plates each protrudes to form a mounting portion, a distance between the two mounting portions in a width direction is less than a width of the bottom plate; and the two mounting portions are at the same height.

11. The battery frame according to claim 1, wherein a width of each of the plurality of boss portions is less than a width of the bottom plate;
wherein multiple of the plurality of boss portions on a same side plate are arranged spaced apart in a height direction of the side plate,
wherein the plurality of boss portions on the two side plates are symmetrically arranged in the height direction of the side plates, and
wherein two of the plurality of boss portions at a same height and the two side plates enclose to form one of the one or more accommodating cavities, and a distance between the two boss portions at the same height in width direction is less than the width of the bottom plate.

12. The battery frame according to claim 1, wherein two of the plurality of boss portions at lowermost positions of the two side plates abut against the bottom plate.

13. A carrier, comprising at least one power battery; and a battery frame, wherein the battery frame comprises: a bottom plate, and two side plates,
wherein the bottom plate and the two side plates are of an integrally-formed structure;
wherein the two side plates are symmetrically connected to two sides of the bottom plate, the bottom plate and the two side plates enclose to form a channel body with an upward opening, and two ends of the channel body, in a length direction, each has an opening;
wherein inner side walls of the two side plates each protrudes to form a plurality of boss portions, and the plurality of boss portions and the two side plates enclose to form one or more accommodating cavities for mounting power batteries; and
wherein the at least one power battery is mounted in the one or more accommodating cavities.

14. The carrier according to claim 13, wherein the power battery comprises an electric core, and inner walls of the accommodating cavity surround the electric core to serve as a housing of the power battery.

15. The battery frame according to claim 1, wherein the bottom plate and the two side plates are of an extruded profile integrated molding structure.

16. The battery frame according to claim 1, wherein at least one of the inner side walls of the side plates and the plurality of boss portions is provided with a guide groove.

17. The battery frame according to claim 4, wherein the cover plate is an integrally formed aluminum alloy cover plate.

18. The battery frame according to claim 4, wherein the cover plate is of a porous profile-type structure.

19. The battery frame according to claim 6, wherein the protective plate is an integrally formed aluminum alloy protective plate.

20. The battery frame according to claim 6, wherein the protective plate is of a porous profile-type structure.
